(19) United States
(12) Patent Application Publication
(10) Pub. No.: US 2015/0068222 A1
(43) Pub. Date: Mar. 12, 2015

(54) METHOD FOR RE-LIQUEFYING BOIL-OFF GAS GENERATED AT LIQUID HYDROGEN STORAGE TANK

(71) Applicant: KAWASAKI JUKOGYO KABUSHIKI KAISHA, Hyogo (JP)

(72) Inventors: Kazuhide Hakamada, Akashi-shi (JP); Seiji Yamashita, Kobe-shi (JP); Toshihiro Kkomiya, Kamagaya-shi (JP); Shoji Kamiya, Kakogawa-shi (JP); Kenjiro Shindo, Kobe-shi (JP)

(73) Assignee: KAWASAKI JUKOGYO KABUSHIKI KAISHA, Hyogo (JP)

(21) Appl. No.: 14/376,509

(22) PCT Filed: Apr. 17, 2013
(86) PCT No.: PCT/JP2013/061417

§ 371 Date: Aug. 4, 2014

(30) Foreign Application Priority Data
May 22, 2012 (JP) 2012-116765

(51) Int. Cl. F17C 9/02; F17C 13/00

(52) U.S. Cl. CPC F17C 9/02; F17C 13/004; F17C 2221/012; F17C 2223/0161
USPC 62/48.2; 62/53.2

(57) ABSTRACT

The boil-off gas discharged from a liquid hydrogen storage tank on a liquid hydrogen transport vessel (16) is introduced into the liquid hydrogen stored within liquid hydrogen storage tanks (19, 20) disposed on the ground by passing through a boil-off gas introduction path (17). At least a portion of the boil-off gas is re-liquefied by means of the cold temperature of the liquid hydrogen. The boil-off gas that was not re-liquefied and the gasified hydrogen generated as a consequence of the liquid hydrogen within the liquid hydrogen storage tanks (19, 20) gasifying are mixed with raw material hydrogen by being supplied to the raw material hydrogen path (11) of a liquid hydrogen production device (HS) by passing through a gasified hydrogen discharge path (21). The boil-off gas and the gasified hydrogen are re-liquefied by means of the liquid hydrogen production device (HS).

### TECHNICAL FIELD

The present invention relates to a method of re-liquefying boil-off gas generated in a liquid hydrogen reservoir of a liquid hydrogen transporting ship or the like.

### BACKGROUND ART

Hydrogen is conventionally and widely used as a raw material, a reduction agent or the like in various technical fields such as chemical industries, petroleum refinery industries, iron manufacturing industries or the like. Meanwhile, policy to reduce carbon-dioxide emissions is recently adopted on a global scale while price of fossil fuel such as crude oil is continuously running up. Thus, in recent years, it is intended to utilize hydrogen as fuel or energy sources in various technical fields. In particular, it is intended to utilize hydrogen as fuel for engines of automobiles or turbines of electricity generators. Hydrogen is conventionally produced by means of a steam reforming process of hydrocarbons, an electrolysis process of water or the like. Meanwhile, it is also possible to produce hydrogen by means of a hydrogen producing system which produces hydrogen using low-grade coal such as lignite or the like as one main raw material.

Meanwhile, when hydrogen is produced, for example by using low-grade coal as one main raw material, the hydrogen producing system is generally established near a producing area of the low-grade coal. On the other hand, a market area of hydrogen mainly exists in a populated area such as an urban area or the like, which is generally distant from the producing area of the low-grade coal. Accordingly, it is necessary to transport hydrogen produced in the hydrogen producing system to the market area of hydrogen.

In general, when hydrogen is transported to the market area across a sea or ocean, hydrogen produced in the hydrogen producing system is cooled so as to be liquefied by a hydrogen liquefier, and stored in a liquid hydrogen storage tank as disclosed, for example in JP 2005-241232 A. Then, liquid hydrogen is conveniently transported to the market area. Thus, in order to transport the liquid hydrogen across the sea or ocean, in general, a liquid hydrogen transporting ship is used, which is equipped with a liquid hydrogen vessel for storing the liquid hydrogen while keeping it at very low temperature.

### SUMMARY OF INVENTION

### Problems to be Solved by the Invention

When the liquid hydrogen is intermittently transported to the market area of hydrogen by means of the liquid hydrogen transporting ship, at first, the liquid hydrogen stored in the liquid hydrogen storage tank is supplied to the liquid hydrogen vessel of the liquid hydrogen transporting ship, which is harboring in a port (referred to as “shipping port” hereinafter) near the place where the hydrogen liquefier or the liquid hydrogen storage tank is located. Then, the liquid hydrogen transporting ship travels across the sea or ocean and reaches another port (referred to as “landing port” hereinafter) near the market area of hydrogen. Thus, the liquid hydrogen stored in the liquid hydrogen vessel of the liquid hydrogen transporting ship is supplied to another liquid hydrogen storage tank established near the landing port. After that, the liquid hydrogen transporting ship harboring in the landing port, whose liquid hydrogen vessel still holds a suitable amount (for example, a few percent in volume with respect to the volume of the liquid hydrogen vessel) of liquid hydrogen for keeping the liquid hydrogen vessel in a very cold state, returns to the shipping port.

Thus, in the shipping port, the liquid hydrogen stored in the liquid hydrogen storage tank near the shipping port is supplied to the liquid hydrogen vessel of the liquid hydrogen transporting ship again. On that occasion, the temperature of the liquid hydrogen vessel of the liquid hydrogen transporting ship has been elevated because heat outside of the liquid hydrogen vessel was transmitted to the liquid hydrogen vessel when the liquid hydrogen transporting ship was traveling from the landing port to the shipping port or when the liquid hydrogen transporting ship was harboring in the shipping port. In particular, the temperature in the upper portion of the liquid hydrogen vessel has become higher than the saturation temperature of the liquid hydrogen. In consequence, when the liquid hydrogen in the liquid hydrogen storage tank is supplied to the liquid hydrogen vessel, the supplied liquid hydrogen is partially vaporized resulting from the difference between the temperature of the liquid hydrogen vessel and the temperature of the supplied liquid hydrogen so that boil-off gas is generated. Thus, it is necessary to treat the boil-off gas.

In order to address this problem, it is probable to use such a solution to mix the boil-off gas generated in the liquid hydrogen vessel of the liquid hydrogen transporting ship with gaseous hydrogen as a raw material supplied from the hydrogen producing system to the hydrogen liquefier, and then re-liquefy it by means of the hydrogen liquefier for its reuse. Meanwhile, the boil-off gas is generated in very large amounts over a short time because the liquid hydrogen transporting ship is merely harboring over a short time of one day or a few days. Thus, if the boil-off gas is simply used in very large amounts as a raw material of the hydrogen liquefier, the raw material supply of the hydrogen liquefier is temporarily and drastically increased. In consequence, there may be caused such a problem that it brings on a trouble in operations of the hydrogen liquefier, which is designed on the assumption that gaseous hydrogen as the raw material is supplied at a constant flow rate. Similar problems may be caused as for boil-off gas generated in any liquid hydrogen reservoir equipped in a means for transporting the liquid hydrogen other than the liquid hydrogen transporting ship.

The present invention, which has been developed to solve the conventional problem described above, has an object to provide a means which can mix boil-off gas of large amounts with gaseous hydrogen as a raw material supplied from a hydrogen producing system to a hydrogen liquefier and can re-liquefy the boil-off gas so as to reuse as liquid hydrogen without bringing on any trouble as for operations of the hydrogen liquefier, the boil-off gas being generated over a short time in a liquid hydrogen reservoir of a transporting means for transporting liquid hydrogen, such as a liquid hydrogen vessel of a liquid hydrogen transporting ship or the like.

### Means for Solving the Problems

In a method of re-liquefying boil-off gas generated in a primary liquid hydrogen reservoir according to the present invention, which has been developed to achieve the above-mentioned object, at first, the boil-off gas is introduced into liquid hydrogen stored in a secondary liquid hydrogen reservoir or a liquid hydrogen storage tank so that at least a part of the boil-off gas is liquefied by means of cryogenic heat energy of the liquid hydrogen. Then, the remaining not-liquefied part of the boil-off gas and vaporized hydrogen gas generated in the secondary liquid hydrogen reservoir are supplied to a liquid hydrogen producing unit of a liquid hydrogen producing apparatus for producing the liquid hydrogen from gaseous hydrogen, the liquid hydrogen producing apparatus including a refrigeration cycle unit in which circulating hydrogen flows as a refrigerant, in addition to the liquid hydrogen producing unit. Thus, the remaining not-liquefied part of the boil-off gas and the vaporized hydrogen gas are liquefied by the liquid hydrogen producing apparatus.

In the method of re-liquefying the boil-off gas according to the present invention, it is preferable that the temperature of the liquid hydrogen stored in the secondary liquid hydrogen reservoir is lower than the saturation temperature or boiling point of the liquid hydrogen. Boil-off gas generated in a liquid hydrogen vessel of a liquid hydrogen transporting ship is an example of the boil-off gas which may be re-liquefied by the method according to the present invention.

### Advantages of the Invention

According to the present invention, boil-off gas which is generated in a primary liquid hydrogen reservoir, for example a liquid hydrogen vessel of a liquid hydrogen transporting ship, is introduced into liquid hydrogen stored in a secondary liquid hydrogen reservoir so that at least a part of the boil-off gas is liquefied by means of cryogenic heat energy of the liquid hydrogen. Meanwhile, the remaining boil-off gas, which has not been liquefied in the secondary liquid hydrogen reservoir, is supplied to the liquid hydrogen producing apparatus together with the vaporized hydrogen gas which is generated by vaporization of the liquid hydrogen stored in the secondary liquid hydrogen reservoir, and then re-liquefied.

Thus, when the primary liquid hydrogen reservoir of empty state is filled with the liquid hydrogen, the boil-off gas is generated in large amounts within the primary liquid hydrogen reservoir on the occasion that the liquid hydrogen is supplied thereto, because the temperature of the primary liquid hydrogen reservoir has been elevated. When the boil-off gas generated as described above is introduced into the liquid hydrogen stored in the secondary liquid hydrogen reservoir, at least a part of the boil-off gas, generally most of the boil-off gas is liquefied. In consequence, it is avoided such a matter that the boil-off gas is supplied in large amounts to the liquid hydrogen producing apparatus over a short time. In concrete terms, even if the boil-off gas is generated in large amounts over a short time within the primary liquid hydrogen reservoir, the production of the boil-off gas as a whole is smoothed by the secondary liquid hydrogen reservoir so that the flow rate of the boil-off gas supplied to the liquid hydrogen producing apparatus, namely the loading factor of the liquid hydrogen producing apparatus is averaged. Accordingly, it is possible to re-liquefy the boil-off gas in the liquid hydrogen producing apparatus so as to reuse as liquid hydrogen without producing any trouble as for operations of the liquid hydrogen producing apparatus.

### BRIEF DESCRIPTION OF DRAWING

FIG. 1 is a schematic view showing a system configuration of a liquid hydrogen producing apparatus used for a method of re-liquefying boil-off gas according to the present invention.

### BEST MODE FOR CARRYING OUT THE INVENTION

An embodiment of the present invention will be described in detail hereinafter, with reference to the accompanying drawing.

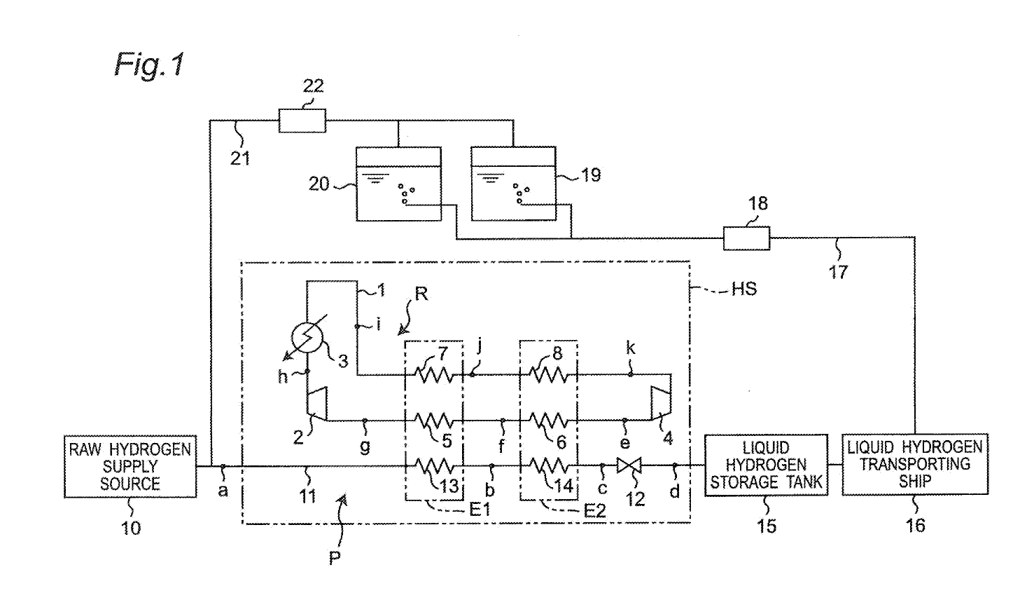

As shown in FIG. 1, a liquid hydrogen producing apparatus HS according to an embodiment of the present invention is equipped with a refrigeration cycle unit R in which hydrogen circulates as a refrigerant (referred to as “circulating hydrogen” hereinafter), and a liquid hydrogen producing unit P for producing liquid hydrogen by cooling pressurized gaseous hydrogen (referred to as “raw hydrogen” hereinafter) as a raw material by means of the refrigeration cycle unit R and then adiabatically expanding the raw hydrogen.

The refrigeration cycle unit R is equipped with a hydrogen circulating passage 1 of a circular configuration, through which the circulating hydrogen flows in circle. The circulating hydrogen flows in circle clockwise in the hydrogen circulating passage 1 in view of the positional relationship shown in FIG. 1. Hereinafter, for the sake of convenience, the upstream side and the downstream side with respect to the direction, along which the circulating hydrogen flows, are merely referred to as “upstream” and “downstream”, respectively. The hydrogen circulating passage 1 is equipped with a compressor 2, a circulating hydrogen cooler 3 located at the downstream side of the compressor 2 and an expansion turbine 4 located at the downstream side of the circulating hydrogen cooler 3, each of which is interposed in the hydrogen circulating passage 1.

The compressor 2, which may be, for example a compression machine driven by an electric motor, adiabatically compresses the circulating hydrogen in the state of ordinary pressure (for example, 0.1 MPaA) and ordinary temperature (for example, 300K) so as to make the circulating hydrogen become such a state of high pressure (for example, 2 MPaA) and high temperature (for example, 780K). The circulating hydrogen cooler 3, which may be, for example a heat exchanger using cooling water at low temperature as a cooling medium, cools the circulating hydrogen at high pressure and high temperature so as to make the circulating hydrogen become such a state of ordinary temperature while maintaining its high pressure. Thus, the circulating hydrogen at high pressure and ordinary temperature is cooled before reaching the expansion turbine 4 by first and second heat exchangers E1 and E2 as described later in detail so that the circulating hydrogen reaches such a state of very low temperature (for example, 40K) while maintaining its pressure. The expansion turbine 4, which may be a turbine for transforming pressure energy or kinetic energy of a gas at high pressure into mechanical energy and then outputs the mechanical energy outward, is driven by the circulating hydrogen at high pressure and very low temperature while the expansion turbine 4 lowers the pressure and temperature of the circulating hydrogen to liquefy at least a part of the circulating hydrogen so that the circulating hydrogen reaches such a state of ordinary pressure and extremely low temperature (for example, 20K). Alternatively, instead of the expansion turbine 4, it is possible to use an expansion machine such as a Joule-Thomson valve or the like, which adiabatically expands the circulating hydrogen.

In addition, the hydrogen circulating passage 1 is equipped with first and second low-temperature heat exchanging elements 5 and 6, each of which is disposed at a respective position located downstream of the expansion turbine 4 and upstream of the compressor 2. Moreover, the hydrogen circulating passage 1 is equipped with first and second high-temperature heat exchanging elements 7 and 8, each of which is disposed at a respective position located downstream of the circulating hydrogen cooler 3 and upstream of the expansion turbine 4. The first low-temperature heat exchanging element 5 and the first high-temperature heat exchanging element 7 are disposed at mutually corresponding positions so as to mutually exchange heat thereof. The second low-temperature heat exchanging element 6 and the second high-temperature heat exchanging element 8 are disposed at mutually corresponding positions so as to mutually exchange heat thereof. Each of the first low-temperature heat exchanging element 5 and the first high-temperature heat exchanging element 7 is a component of the first heat exchanger E1 described later in detail, while each of the second low-temperature heat exchanging element 6 and the second high-temperature heat exchanging element 8 is a component of the second heat exchanger E2 described later in detail.

The liquid hydrogen producing unit P is equipped with a raw hydrogen passage 11, through which the raw hydrogen in the state of high pressure (for example, 2 MPaA) and ordinary temperature supplied from a raw hydrogen supply source 10 flows. A Joule-Thomson valve 12 is connected to the downstream end of the raw hydrogen passage 11 with respect to the direction along which the raw hydrogen flows (rightward in view of the positional relationship shown in FIG. 1). In addition, a first raw hydrogen cooling element 13 and a second raw hydrogen cooling element 14 are interposed in the raw hydrogen passage 11, in turn from the upstream side to the downstream side with respect to the direction along which the raw hydrogen flows. The first and second raw hydrogen cooling elements 13 and 14 cool the raw hydrogen in the state of high pressure and ordinary temperature so that the raw hydrogen reaches such a state of very low-temperature (for example, 40K) while approximately maintaining its high pressure. The Joule-Thomson valve 12 adiabatically expands the raw hydrogen in the state of high pressure and very low-temperature so as to lower the pressure and temperature of the raw hydrogen. In consequence, at least a part of the raw hydrogen is liquefied so that liquid hydrogen is produced. Alternatively, an expansion valve other than the Joule-Thomson valve 12 may be used in order to liquefy the raw hydrogen. The first raw hydrogen cooling element 13 may be a component of the first heat exchanger E1 described later in detail while the second raw hydrogen cooling element 14 may be a component of the second heat exchanger E2 described later in detail.

In the liquid hydrogen producing apparatus HS, the first and second heat exchangers E1 and E2 are arranged across the refrigeration cycle unit R and the liquid hydrogen producing unit P, the first heat exchanger E1 including the first low-temperature heat exchanging element 5, the first high-temperature heat exchanging element 7 and the first raw hydrogen cooling element 13, and the second heat exchanger E2 including the second low-temperature heat exchanging element 6, the second high-temperature heat exchanging element 8 and the second raw hydrogen cooling element 14. In each of the first and second heat exchangers E1 and E2, the circulating hydrogen flowing through the hydrogen circulating passage 1 at the position downstream of the expansion turbine 4 and upstream of the compressor 2, cools the circulating hydrogen flowing through the hydrogen circulating passage 1 at the position downstream of the circulating hydrogen cooler 3 and upstream of the expansion turbine 4, and further cools the raw hydrogen flowing through the raw hydrogen passage 11.

In the apparatus according to the embodiment shown in FIG. 1, two heat exchangers E1 and E2 are arranged across the refrigeration cycle unit R and the liquid hydrogen producing unit P. However, the number of the heat exchangers to be equipped is not limited two, and therefore it is possible to use three or more heat exchangers (for example, three, four, five . . . ). In other words, the number of the heat exchangers to be equipped may be preferably determined depending on the heat transfer area of each heat exchanger and other heat transfer properties of each heat exchanger.

Hereinafter, it will be described how the thermodynamic states of the circulating hydrogen or raw hydrogen flowing in the refrigeration cycle unit R or liquid hydrogen producing unit P may be changed. At first, the state changes of the circulating hydrogen flowing from the expansion turbine 4 to the compressor 2 through the hydrogen circulating passage 1 will be described. The circulating hydrogen in the state of ordinary pressure (for example, 0.1 MPaA) and extremely low temperature (for example, 20K), which has flowed away from the expansion turbine 4 and has been at least partially liquefied, cools the circulating hydrogen flowing through the second high-temperature heat exchanging element 8 as well as the raw hydrogen flowing through the second raw hydrogen cooling element 14 when it flows through the second low-temperature heat exchanging element 6. In consequence, the temperature of the circulating hydrogen in the state of ordinary pressure, which has flowed away from the second low-temperature heat exchanging element 6 (second heat exchanger E2) has been elevated to a slightly higher temperature (for example, 80K). On that occasion, the liquefied part in the circulating hydrogen is vaporized when it flows through the second low-temperature heat exchanging element 6.

The circulating hydrogen, which has flowed away from the second low-temperature heat exchanging element 6 (second heat exchanger E2), cools the circulating hydrogen flowing through the first high-temperature heat exchanging element 7 as well as the raw hydrogen flowing through the first raw hydrogen cooling element 13 when it flows through the first low-temperature heat exchanging element 5. In consequence, the temperature of the circulating hydrogen in the state of ordinary pressure, which has flowed away from the first low-temperature heat exchanging element 5 (first heat exchanger E1) has been elevated to ordinary temperature (for example, 300K). Then, the circulating hydrogen in the state of ordinary pressure and ordinary temperature flows into the compressor 2. Thus, the circulating hydrogen is adiabatically compressed by the compressor 2 so that it becomes such a state of high pressure (for example, 2 MPaA) and high temperature (for example, 780K).

Next, the state changes of the circulating hydrogen flowing from the compressor 2 to the expansion turbine 4 through the hydrogen circulating passage 1 will be described hereinafter. The gaseous circulating hydrogen in the state of high pressure and high temperature, which has flowed away from the compressor 2, is cooled at first by the circulation hydrogen cooler 3 so as to reach such a state of ordinary temperature (for example, 300K) and high pressure. Then, the circulating hydrogen in the state of high pressure and ordinary temperature is cooled by the circulating hydrogen flowing through the first low-temperature heat exchanging element 5 so as to reach such a state of very low-temperature (for example, 80K) when it flows through the first high-temperature heat exchanging element 7. The circulating hydrogen in the state of high pressure and very low temperature, which has flowed away from the first high-temperature heat exchanging element 7 (first heat exchanger E1) is cooled by the circulating hydrogen flowing through the second low-temperature heat exchanging element 6 so as to reach such a state of further lower-temperature (for example, 40K) when it flows through the second high-temperature heat exchanging element 8. Then, the circulating hydrogen in the state of high pressure and very low temperature flows into the expansion turbine 4. Thus, the circulating hydrogen is expanded by the expansion turbine 4 so as to become such a state of ordinary pressure (for example, 0.1 MPaA) and extremely low temperature (for example, 20K) so that the circulating hydrogen is at least partially liquefied.

Moreover, the state changes of the raw hydrogen flowing from the raw hydrogen supply source 10 to the Joule-Thomson valve 12 through the raw hydrogen passage 11 will be described hereinafter. The raw hydrogen in the state of high pressure (for example, 2 MPaA) and ordinary temperature (for example, 300K) supplied by the raw hydrogen supply source 10 is cooled by the circulating hydrogen flowing through the first low-temperature heat exchanging element 5 so as to become such a state of very low temperature (for example, 80K) when it flows through the first raw hydrogen cooling element 13. The raw hydrogen in the state of high pressure and very low temperature, which has flowed away from the first raw hydrogen cooling element 13 (first heat exchanger E1) is cooled by the circulating hydrogen flowing through the second low-temperature heat exchanging element 6 so as to reach such a state of further lower-temperature (for example, 40K) when it flows through the second raw hydrogen cooling element 14.

Then, the raw hydrogen in the state of high pressure and very low temperature is expanded by means of the Joule-Thomson expansion process when it passes through the Joule-Thomson valve 12 so as to become such a state of ordinary pressure (for example, 0.1 MPaA) and extremely low temperature (for example, 20K) so that the raw hydrogen is at least partially liquefied. The liquefied raw hydrogen, namely liquid hydrogen as a product of the liquid hydrogen producing apparatus HS, is stored in a liquid hydrogen storage tank 15. The liquid hydrogen stored in the liquid hydrogen storage tank 15 is conveniently supplied to a liquid hydrogen vessel of a liquid hydrogen transporting ship 16 which is harboring in a port (shipping port) near the area where the liquid hydrogen producing apparatus HS is located.

Table 1 collectively shows thermodynamic states of the circulating hydrogen or raw hydrogen at respective positions in the refrigeration cycle unit R or the liquid hydrogen producing unit P, the positions being indicated by the reference symbols a-k in FIG. 1. In Table 1, the symbol “G” denotes a gas state while the symbol “L” denotes a liquid state.

TABLE 1
Thermodynamic states of circulating hydrogen or raw hydrogen

| Position | a | b | c | d | e | f | g | h | i | j | k |
|---|---|---|---|---|---|---|---|---|---|---|---|
| State | G | G | G | L | L | G | G | G | G | G | G |
| Temp. [K] | 300 | 80 | 40 | 20 | 20 | 80 | 300 | 780 | 300 | 80 | 40 |
| Pres. [MPaA] | 2.0 | 2.0 | 2.0 | 0.1 | 0.1 | 0.1 | 0.1 | 2.0 | 2.0 | 2.0 | 2.0 |

Hereinafter, it will be described a method or system according to the present invention, for re-liquefying the boil-off gas which is generated on the occasion of filling the liquid hydrogen vessel of the liquid hydrogen transporting ship 16 (referred to as “ship vessel” hereinafter) with the liquid hydrogen. After the liquid hydrogen transporting ship 16, in which the ship vessel (namely, primary liquid hydrogen reservoir) holds a suitable amount (for example, a few percent in volume with respect to the volume of the ship vessel) of liquid hydrogen for keeping the ship vessel cold, has reached the shipping port near the liquid hydrogen storage tank 15 and has harbored therein, the liquid hydrogen stored in the liquid hydrogen storage tank 15 is supplied to the ship vessel. Meanwhile, in general, it is estimated that the liquid hydrogen transporting ship 16 will be harboring over a short time of one day or a few days. On that occasion, it is estimated that the temperature of the ship vessel, particularly the temperature in the upper portion of the ship vessel has become higher than the saturation temperature or boiling point (20.28K) of the liquid hydrogen because heat outside of the ship vessel was transmitted to the ship vessel when the liquid hydrogen transporting ship 16 was traveling or harboring.

In consequence, the liquid hydrogen supplied to the ship vessel (primary liquid hydrogen reservoir) is partially vaporized resulting from the difference between the temperature of the ship vessel and the temperature of the supplied liquid hydrogen so that a large amount of boil-off gas is generated over a short time. In general, the temperature of the boil-off gas generated in the ship vessel is 50-80K when it has been started to supply the liquid hydrogen. Then, when the filling fraction of the liquid hydrogen in the ship vessel becomes larger, the ship vessel is cooled by the liquid hydrogen. Thus, because the temperature of the ship vessel is gradually lowered, the temperature of the boil-off gas is lowered so as to become a temperature in the range of 20-50K, which is a temperature near the temperature at which gaseous hydrogen is liquefied.

According to the method of re-liquefying the boil-off gas according to the present invention, the boil-off gas in the range of 20-80K, which is discharged from the ship vessel (primary liquid hydrogen reservoir), is introduced into the liquid hydrogen stored in secondary liquid hydrogen reservoirs or liquid hydrogen storage tanks 19 and 20 through a boil-off gas introducing passage 17 by a blower 18 which is interposed in the boil-off gas introducing passage 17. The peripheral surface of the boil-off gas introducing passage 17 is insulated so as to be kept cold by means of insulating materials in order to prevent or reduce temperature rise of the boil-off gas due to the heat transmitted thereto from outside although the insulating materials are not shown in the drawing. The blower 18 produces such a discharge pressure to enable the boil-off gas to be blown into the liquid hydrogen at a position near the bottom of each of the secondary liquid hydrogen reservoirs 19 and 20. A compressor may be used instead of the blower 18. If the boil-off gas has a higher pressure to a certain extent, the blower 18 may be eliminated.

Each of the secondary liquid hydrogen reservoirs 19 and 20 is a spherical or cylindrical tank of large volume (for example, from several hundred cubic meters to several tens of thousands cubic meters), which is established on the ground. Each of the secondary liquid hydrogen reservoirs 19 and 20 conveniently receives and stores liquid hydrogen having a temperature lower than the saturation temperature or boiling point (20.28K at normal pressure) thereof and supplied from various supply sources of liquid hydrogen while it conveniently supplies the liquid hydrogen to various facilities or transportation means which consume the liquid hydrogen. The peripheral surface of each of the secondary liquid hydrogen reservoirs 19 and 20 is insulated so as to be kept cold by means of insulating materials in order to prevent or reduce the heat transmitted thereto from outside although the insulating materials are not shown in the drawing. Because the liquid hydrogen conveniently moves in and out with respect to the secondary liquid hydrogen reservoirs 19 and 20 as described above, each of the secondary liquid hydrogen reservoirs 19 and 20 always stores liquid hydrogen having a temperature lower than the saturation temperature or boiling point of the liquid hydrogen. Although the system according to the embodiment shown in FIG. 1 is provided with two secondary liquid hydrogen reservoirs, the number of the secondary liquid hydrogen reservoirs is not limited to two. That is, the number of the secondary liquid hydrogen reservoirs may be larger than two or smaller than two.

At least a part (namely, all or a part) of the boil-off gas introduced into the liquid hydrogen in the secondary liquid hydrogen reservoirs 19 and 20 is re-liquefied by means of cryogenic heat energy of the liquid hydrogen whose temperature is lower than the saturation temperature or boiling point of the liquid hydrogen. Thus, if apart of the boil-off gas is not liquefied, the not-liquefied part of the boil-off gas is discharged from the secondary liquid hydrogen reservoirs 19 and 20, and then supplied to the liquid hydrogen producing apparatus HS together with vaporized hydrogen gas generated by virtue of vaporization of the liquid hydrogen in the secondary liquid hydrogen reservoirs 19 and 20, as described later. On that occasion, because the boil-off gas is introduced into the secondary liquid hydrogen reservoirs 19 and 20, the heat quantity of the liquid hydrogen in the secondary liquid hydrogen reservoirs 19 and 20 is slightly increased so that the amount of the vaporized hydrogen gas is correspondingly increased.

In order to discharge the boil-off gas and the vaporized hydrogen gas in the secondary liquid hydrogen reservoirs 19 and 20, and to supply them into the liquid hydrogen producing apparatus HS, there is provided a vaporized hydrogen discharge passage 21, which is connected to the top portion of each of the secondary liquid hydrogen reservoirs 19 and 20 and to an upstream portion of the raw hydrogen passage 11 relative to the first raw hydrogen cooling element 13. Moreover, a further compressor 22 is interposed at a portion of the vaporized hydrogen discharge passage 21. The further compressor 22 compresses the boil-off gas or vaporized hydrogen at ordinary pressure discharged from the secondary liquid hydrogen reservoirs 19 and 20 so as to have a pressure equal to or higher than the pressure of the raw hydrogen (for example, 2.0 MPaA), and then supplies the boil-off gas or vaporized hydrogen to the raw hydrogen passage 11 at an upstream position relative to the first raw hydrogen cooling element 13. The boil-off gas or vaporized hydrogen supplied to the raw hydrogen passage 11 is mixed with the raw hydrogen and then liquefied together with the raw hydrogen so as to become liquid hydrogen. Because the boil-off gas, the vaporized hydrogen and the raw hydrogen, each of which is gaseous hydrogen alike as a substance, are completely and uniformly mixed together, it is impossible to actually distinguish them.

In the method or system for re-liquefying the boil-off gas according to the present invention, at least a part of, generally most of the boil-off gas generated in the ship vessel (primary liquid hydrogen tank) is liquefied by the liquid hydrogen in the secondary liquid hydrogen reservoirs 19 and 20, the temperature of the liquid hydrogen being lower than the saturation temperature or boiling point of the liquid hydrogen. In consequence, even if the boil-off gas is generated in large amounts within the ship vessel over a short time, most of the boil-off gas is re-liquefied by the liquid hydrogen in the secondary liquid hydrogen reservoirs 19 and 20. Accordingly, it is prevented that the boil-off gas is supplied in large amounts to the liquid hydrogen producing apparatus HS over a short time. Thus, even if the boil-off gas is generated in large amounts within the ship vessel over a short time, the flow rate of the boil-off gas supplied to the liquid hydrogen producing apparatus HS, namely the loading factor of the liquid hydrogen producing apparatus HS is not drastically increased so that the flow rate is uniformed or averaged. Therefore, it is possible to re-liquefy the boil-off gas by means of the liquid hydrogen producing apparatus HS so as to reuse as liquid hydrogen, without bring on any trouble as for operations of the liquid hydrogen producing apparatus HS.

### INDUSTRIAL APPLICABILITY

To sum it up, a method of re-liquefying boil-off gas of liquid hydrogen according to the present invention is useful as a method for treating the boil-off gas generated in a liquid hydrogen reservoir. In particular, the method according to the present invention is suitable for re-liquefying boil-off gas generated on the occasion that a liquid hydrogen vessel of a liquid hydrogen transporting ship is filled with liquid hydrogen, in the case that the liquid hydrogen is transported to marked areas by the liquid hydrogen transporting ship.

### EXPLANATION OF REFERENCE NUMERALS

HS Liquid hydrogen producing apparatus, R Refrigeration cycle unit, P Liquid hydrogen producing unit, E1 First heat exchanger, E2 Second heat exchanger, 1 Hydrogen circulating passage, 2 Compressor, 3 Circulating hydrogen cooler, 4 Expansion turbine, 5 First low-temperature heat exchanging element, 6 Second low-temperature heat exchanging element, 7 First high-temperature heat exchanging element, 8 Second high-temperature heat exchanging element, 10 Raw hydrogen supply source, 11 Raw hydrogen passage, Joule-Thomson valve, 13 First raw hydrogen cooling element, 14 Second raw hydrogen cooling element, 15 Liquid hydrogen storage tank, 16 Liquid hydrogen transporting ship, 17 Boil-off gas introducing passage, 18 Blower, 19 Secondary liquid hydrogen reservoir, 20 Secondary liquid hydrogen reservoir, 21 Vaporized hydrogen discharge passage, 22 Further compressor.

1. A method of re-liquefying boil-off gas generated in a primary liquid hydrogen reservoir, the method comprising:
introducing the boil-off gas into liquid hydrogen stored in a secondary liquid hydrogen reservoir so as to liquefy at least a part of the boil-off gas by means of cryogenic heat energy of the liquid hydrogen;
supplying the remaining not-liquefied part of the boil-off gas and vaporized hydrogen gas generated in said secondary liquid hydrogen reservoir, to a liquid hydrogen producing unit of a liquid hydrogen producing apparatus for producing the liquid hydrogen from gaseous hydrogen, said liquid hydrogen producing apparatus including a refrigeration cycle unit in which circulating hydrogen flows as a refrigerant, in addition to said liquid hydrogen producing unit; and
liquefying the remaining not-liquefied part of the boil-off gas and the vaporized hydrogen gas by means of the liquid hydrogen producing apparatus.

2. The method according to claim 1, wherein the temperature of the liquid hydrogen stored in said secondary liquid hydrogen reservoir is lower than the saturation temperature of the liquid hydrogen.

3. The method according to claim 1, wherein the boil-off gas is generated in a liquid hydrogen vessel of a liquid hydrogen transporting ship.

4. The method according to claim 2, wherein the boil-off gas is generated in a liquid hydrogen vessel of a liquid hydrogen transporting ship.
